(19) United States
(12) Patent Application Publication
(10) Pub. No.: US 2026/0235180 A1
(43) Pub. Date: Aug. 13, 2026

(54) ELASTOMERIC BUSHING WITH TRAVEL LIMITER

(71) Applicant: The Pullman Company LLC, Northville, MI (US)

(72) Inventor: Kurt J. STOLL, Milan, OH (US)

(21) Appl. No.: 19/051,259

(22) Filed: Feb. 12, 2025

(51) Int. Cl. F16F 1/38; F16F 1/387

(52) U.S. Cl. CPC F16F 1/3828; F16F 1/3873; F16F 2224/025; F16F 2230/36

(57) ABSTRACT

An elastomeric bushing and travel limiter assembly comprises an elastomeric isolating element positioned radially between an inner component and an outer tube. A travel limiter is ring-shaped and coupled to the inner component. The travel limiter includes an uninterrupted sidewall having circumferentially spaced apart and axially extending segments. The segments each include a first end and an opposite second end. The segments include a first set of adjacent segments interconnected at their first ends by a first web and a second set of adjacent segments interconnected at their second ends by a second web such that the travel limiter is configured to be radially expansible or radially collapsible.

### FIELD

The present disclosure generally pertains to vehicle suspension systems. More particularly, a suspension bushing equipped with one or more travel limiting components is described.

### BACKGROUND

This section provides background information related to the present disclosure which is not necessarily prior art.

Suspension bushings frequently use travel limiting components to define maximum magnitudes of motion between interconnected components of a suspension system. More and more frequently, vehicle manufacturers are implementing suspension bushings that exhibit relatively low or soft rates during normal operating conditions with relatively small displacements to provide enhanced comfort for passengers or smoothness for payloads. These same suspension systems, however, require travel limiting components to assure that proper vehicle responsiveness and control is provided to the vehicle operator during driving events that incur very large displacements between the suspension components. At the limit of the large displacements, it is desirable to provide a very high bushing rate.

Typically, the travel limiting components include external snubbers, brackets or structures that are assembled to the suspension bushing after the elastomeric components have been molded. Assembly of the travel limiting components may be challenging because the travel limiters must provide a snug fit to the bushing to which they are coupled, and the travel limiters are to maintain a desired position during shipping and handling prior to installation of the bushing on a vehicle.

At least two issues have arisen regarding use and assembly of previously known travel limiting components. In one instance, the requirement of a snug or press fit to the bushing may cause the travel limiting component to crack or otherwise fail during assembly of the travel limiting component to the suspension bushing. Additionally, the travel limiting component may not remain at the installed position for an extended period of time prior to assembly to a vehicle. The travel limiting component may, undesirably, move from its initial installed position to a non-conforming position based on the interface between the travel limiting component and suspension bushing including a tapered or otherwise unstable portion of elastomer that is over-molded to a central metal component of the bushing. Accordingly, it may be desirable to provide an improved travel limiter that is easy to install, economical to manufacture, and configured to provide a snug fit to the bushing assembly while maintaining its predetermined position.

### SUMMARY

This section provides a general summary of the disclosure and is not a comprehensive disclosure of its full scope or all of its features.

An elastomeric bushing and travel limiter assembly comprises an elastomeric isolating element positioned radially between an inner component and an outer tube. A travel limiter is ring-shaped and coupled to the inner component. The travel limiter includes an uninterrupted sidewall having circumferentially spaced apart and axially extending segments. The segments each include a first end and an opposite second end. The segments include a first set of adjacent segments interconnected at their first ends by a first web and a second set of adjacent segments interconnected at their second ends by a second web such that the travel limiter is configured to be radially expansible or radially collapsible.

In another arrangement, an elastomeric bushing and travel limiter assembly comprises an elastomeric isolating element positioned radially between an inner component and an outer tube. A travel limiter is ring-shaped and coupled to the inner component. The travel limiter includes an uninterrupted sidewall circumferentially extending along a serpentine path. The travel limiter including first slots that extend through the travel limiter from a first end toward a second end and second slots extending from the second end toward the first end. The first slots and the second slots are interdigitated.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a perspective view of an exemplary elastomeric bushing and travel limiter assembly constructed in accordance with the teachings of the present disclosure;

FIG. 2 is an exploded perspective view of the elastomeric bushing and travel limiter assembly depicted in FIG. 1;

FIG. 3 is a cross-sectional side view of the elastomeric bushing and travel limiter assembly depicted in FIG. 1;

FIG. 4 is a perspective view of an alternate embodiment travel limiter;

FIG. 5 is a cross-sectional side view taken along line 5-5 shown FIG. 4; and

FIG. 6 is a cross-sectional side view taken along line 6-6 as shown in FIG. 4.

Corresponding reference numerals indicate corresponding parts throughout the several views of the drawings.

### DETAILED DESCRIPTION

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

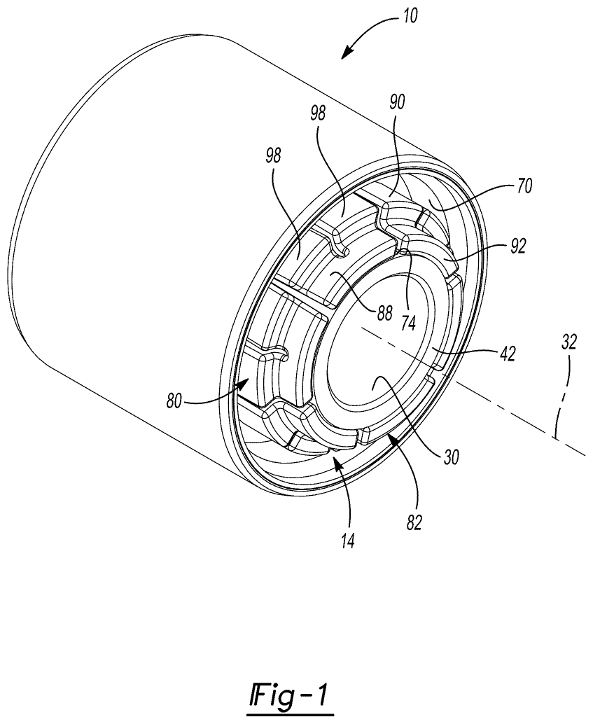

FIGS. 1-3 depict an exemplary elastomeric bushing and travel limiter assembly identified at reference numeral 10. Assembly 10 includes an elastomeric bushing 12, a first travel limiter 14 and a second travel limiter 16. First travel limiter 14 is substantially the same as, if not identical to, second travel limiter 16. Accordingly, only first travel limiter 14 will be described in detail. Similar elements of second travel limiter 16 will be identified with like reference numerals including a prime suffix.

Elastomeric bushing 12 includes an inner component or inner sleeve 20, an outer sleeve 22, and an elastomeric isolating element 24 positioned therebetween. Elastomeric isolating element 24 may be overmolded to only inner sleeve 20 or overmolded to each of inner sleeve 20 and outer sleeve 22. In the embodiment depicted in the figures, outer sleeve 22 includes a radially outwardly extending flange 26. It should be appreciated, however, that flange 26 need not be present.

Inner sleeve 20 is shown as a substantially hollow right circular cylindrical inner component including a central bore 30 extending along a longitudinal axis 32. Inner sleeve 20 includes an outer cylindrical surface 34 extending from a first end 36 to an opposite second end 38. Inner sleeve 20 further includes a first end face 40 and an opposite second end face 42. It should be appreciated that inner component 20 may be alternatively shaped as a solid bar or pin without departing from the scope of the present disclosure.

Elastomeric isolating element 24 includes a body portion 46, an outer hub portion 48, and an inner hub portion 58. Outer hub portion 48 includes an outer surface 50 positioned adjacent to and optionally bonded to an inner surface 52 of outer sleeve 22. Inner hub portion 58 of elastomeric isolating element 24 axially extends the entire length of inner sleeve 20 and is bonded to outer surface 34 of inner sleeve 20. Inner hub portion 58 is primarily provided to simplify the over-molding process and the associated tooling required to bond elastomeric isolating element 24 to inner sleeve 20. As such, inner hub portion 58 exhibits a minimal cross section that tapers from body portion 46 and reduces in thickness as inner hub portion 58 approaches first end face 40 and second end face 42.

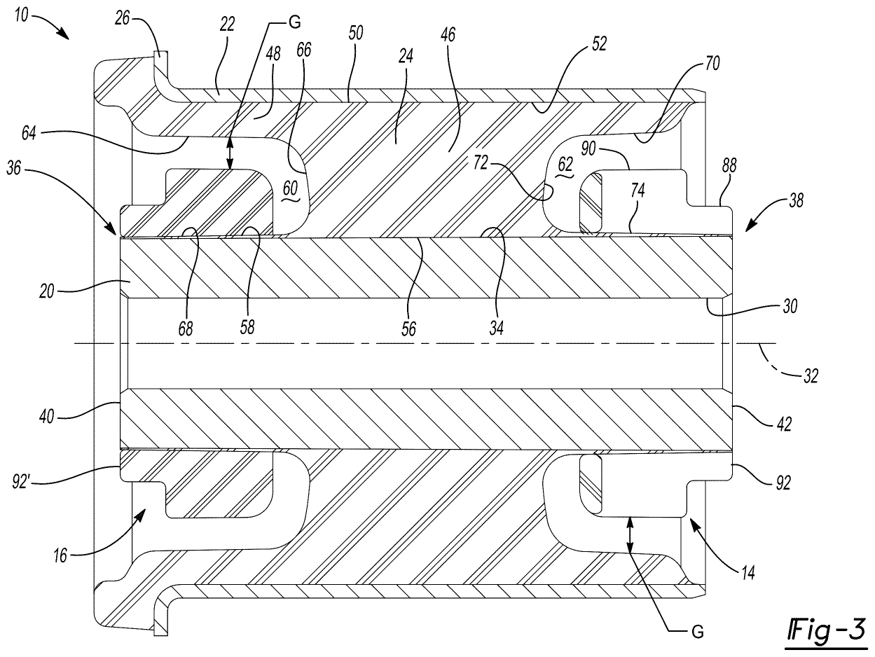

As best depicted in FIG. 3, a first void 60 and a second void 62 are formed by elastomeric isolating element 24 at each end. First void 60 is defined by a surface 64 of outer hub portion 48, a surface 66 of body portion 46, and a surface 68 of inner hub portion 58. Similarly, second void 62 is defined by surfaces 70, 72, and 74.

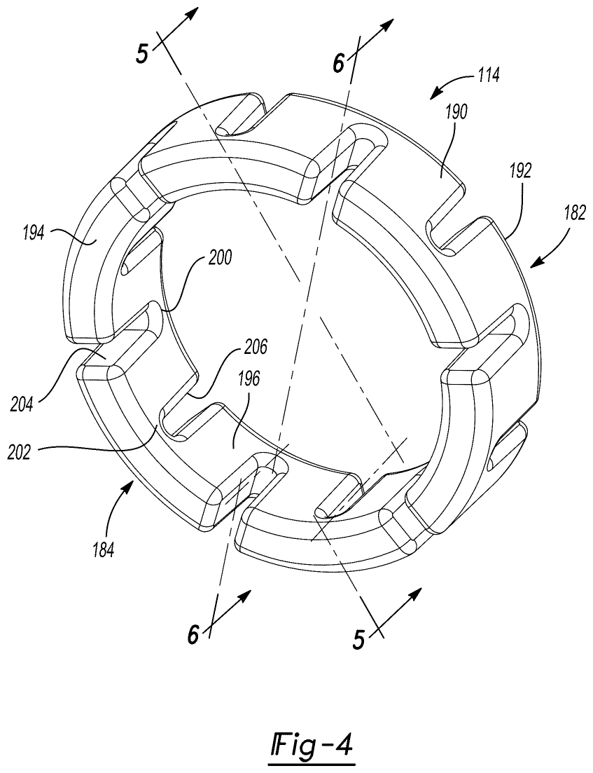

First travel limiter 14 includes a contiguous, uninterrupted wall 80 circumferentially extending in a serpentine manner. First travel limiter 14 includes a first end 82 and an opposite second end 84. In the particular embodiment depicted in FIGS. 1-3, wall 80 is stepped to include a first outer surface 88 having a first outer diameter and a second outer surface 90 having a second outer diameter larger than the first outer diameter. Wall 80 includes a first end face 92 at first end 82 and a second end face 94 positioned at second end 84. The magnitude of the second larger diameter defined by surface 90 is predetermined to set a radial gap G between outer surface 90 and surface 70 as depicted in FIG. 3. Wall 80 includes an inner surface 96 defining an inner diameter. It should be appreciated that several different sizes and configurations of elastomeric bushings exist. Additionally, several different sets of operating conditions are defined by the vehicle manufacturers and gap G may differ based on these variables. Accordingly, different travel limiters 14, 16 may be constructed having predetermined second outer diameters of surface 90 to set gap G at a magnitude particular for the application. In some instances, such as the embodiment depicted in FIGS. 4-6 that will be described in detail later, wall 80 is a constant thickness along its axial length.

Returning to FIGS. 1-3, wall 80 includes a plurality of circumferentially spaced apart and axially elongated segments 98 extending from first end 82 to second end 84. Adjacent segments 98 are connected to one another with one of a first web 100 or a second web 102. When adjacent segments 98 are connected to one another at first end 82, one of first webs 100 interconnects the adjacent segments 98. First slots 104 are positioned between these pairs of segments 98 and terminate at first webs 100. When adjacent segments 98 are connected to one another at their second ends 84, one of second webs 102 interconnects the adjacent segments 98. Second slots 106 are positioned between these pairs of segments 98 and terminate at second webs 102.

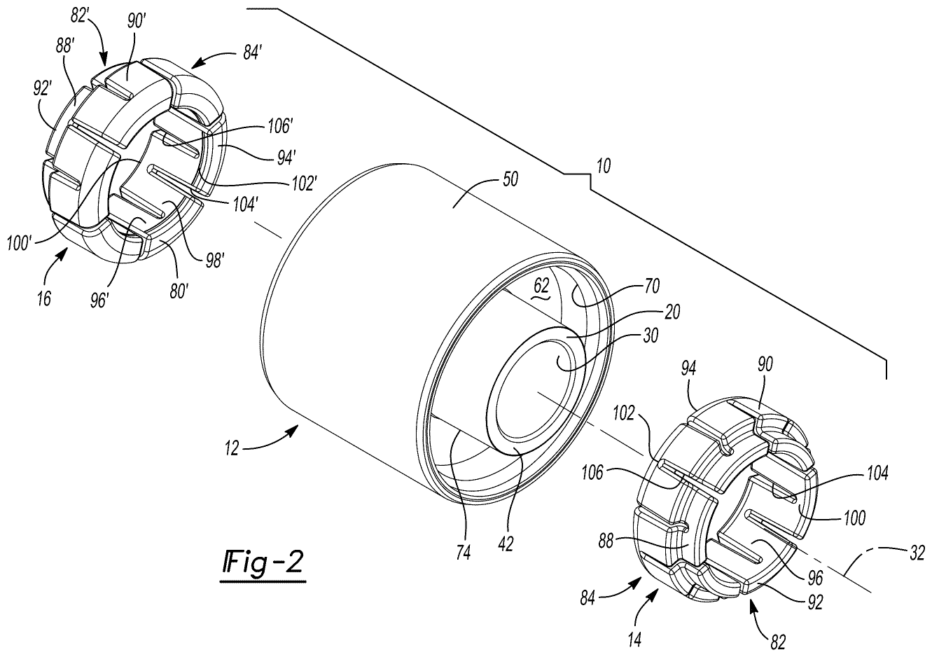

It should be appreciated that the serpentine nature of wall 80 including circumferentially spaced apart segments 98 connected at alternating opposite ends via first and second webs 100, 102 provides a structure that may accommodate changing an inner diameter when subjected to loading such as during press fitting first travel limiter 14 on surface 74 with the press-fit load being reacted by inner sleeve 20. An initial inner diameter of inner surface 96 is manufactured to have a predetermined magnitude in an unloaded condition as depicted in FIG. 2. The predetermined magnitude of the inner diameter is calculated by accounting for the tolerances associated with outer surface 34 of inner sleeve 20 and the thickness of inner hub 58 along surface 74. Based on these calculations, the inner diameter defined by inner surface 96 is set to a dimension lower than a minimum stack-up of tolerances previously calculated to assure a press fit between first travel limiter 14 and elastomeric bushing 12. The serpentine nature of first travel limiter 14 is designed to account for a maximum stack-up dimension of outer surface 34 and inner hub portion 58 when surface 74 is furthest from outer surface 34. Each of the first webs 100 and second webs 102 function as bendable beams that allow each of elongated segments 98 to move radially outwardly during the press fit operation. Accordingly, a larger diameter inner diameter is provided without structural failure of the travel limiter. It is contemplated that each of the first travel limiter 14 and second travel limiter 16 are constructed from a plastic material such as glass fiber reinforced nylon 6/6. This material has elastic properties assuring that each of first webs 100 and second webs 102 may be elastically deformed without taking a permanent set during movement from the initial inner diameter to the installed inner diameter while accounting for the tolerances associated with manufacturing elastomeric bushing 12.

The finalized elastomeric bushing and travel limiter assembly 10 is shown in FIG. 3 in an unloaded condition. First travel limiter 14 is positioned in engagement with surface 74 and spaced apart from surfaces 70, 72 when elastomeric bushing and travel limiter assembly 10 is in the unloaded condition. During instances of high radial loading and relative radial displacement between inner sleeve 20 and outer sleeve 22, surface 70 may contact first travel limiter 14 thereby acting as a radial travel limiter. Instances of high axial loading may cause surface 72 to engage first travel limiter 14 to provide an axial displacement stop. Installation and operation of second travel limiter 16 is substantially the same as previously described in relation to first travel limiter 14.

It is contemplated that first travel limiter 4 may function as either a radially expansible ring as previously described, or alternately as a radially collapsible ring. When acting as a radially collapsible component, first travel limiter 14 is pressed into a bore of a workpiece having an inner diameter sized less than the unloaded outer diameter of first travel limiter 14. The previously described geometry of first travel limiter 14 allows for a reduction in the size of the inner diameter of first travel limiter 14 via bending of first webs 100 and second webs 102.

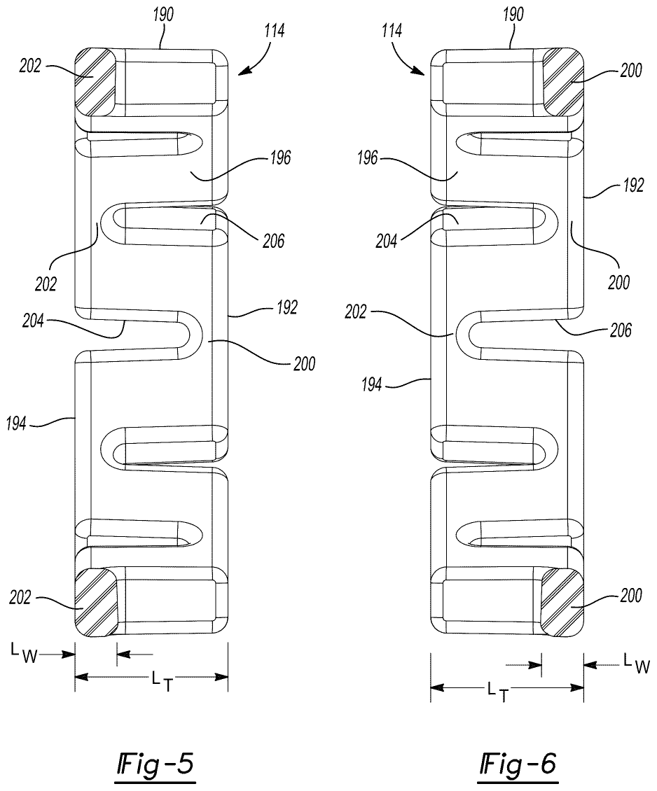

FIGS. 4-6 depict an alternate embodiment travel limiter identified numeral 114. First travel limiter 114 is substantially similar to first travel limiter 14. As such, similar elements will be identified with like reference numerals increased by 100. The main difference between first travel limiter 114 and first travel limiter 14 is that outer surface 190 is not stepped but defines a single-sized outer cylindrical surface. Other features that are common to first travel limiter 14 and first travel limiter 114 include each of first webs 200 and second webs 202 having an axial length identified as L_{W} in FIGS. 5 and 6. First travel limiter 114 includes an axial extent or total length identified as L_{T} in FIGS. 5 and 6. It is envisioned that the axial length L_{W} of each web is less than or equal to than one-third of the total length L_{T} of first travel limiter 114. In a preferred embodiment, web length L_{W} is one-quarter the magnitude of first travel length L_{T}. Such an arrangement provides a structurally robust travel limiter that includes sufficient size for first webs 200 and second webs 202 to function as bending beams allowing first travel limiter 114 to radially outwardly expand during installation but also maintain a clamp load on an inner sleeve such as inner sleeve 20 depicted in FIG. 3. The clamp load retains the travel limiters at their installed position. For example, and in reference to elastomeric bushing and travel limiter assembly 10, it may be desirable to align first end face 92 of first travel limiter 14 with second end face 42 of inner sleeve 20. Similarly, first end face 92′ of second travel limiter 16 is aligned in a common plane with first end face 40 of inner sleeve 20. The geometry previously described causes first travel limiter 14 and second travel limiter 16 to remain at their installed positions during shipping and handling prior to installation to a vehicle.

The foregoing description of the embodiments has been provided for purposes of illustration and description. It is not intended to be exhaustive or to limit the disclosure. Individual elements or features of a particular embodiment are generally not limited to that particular embodiment but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An elastomeric bushing and travel limiter assembly, comprising:
an inner component;
an outer tube;
an elastomeric isolating element positioned radially between the inner component and the outer tube; and
a travel limiter coupled to the inner component, the travel limiter being ring shaped and including an uninterrupted sidewall having circumferentially spaced apart and axially extending segments, the segments each including a first end and an opposite second end, wherein the segments include a first set of adjacent segments interconnected at their first ends by a first web and a second set of adjacent segments interconnected at their second ends by a second web such that the travel limiter is configured to be radially expansible or radially collapsible.

2. The elastomeric bushing and travel limiter assembly of claim 1, wherein the sidewall includes a serpentine shape.

3. The elastomeric bushing and travel limiter assembly of claim 1, wherein the segments extend parallel to one another.

4. The elastomeric bushing and travel limiter assembly of claim 1, wherein the sidewall is spaced apart from a hub of the elastomeric isolating element when in an unload condition and the sidewall is configured to engage the hub of the elastomeric isolating element when in a loaded condition to limit the radial movement of the inner component relative to the outer tube.

5. The elastomeric bushing and travel limiter assembly of claim 1, wherein the sidewall includes a stepped outer surface.

6. The elastomeric bushing and travel limiter assembly of claim 5, wherein the stepped outer surface includes a first portion having an outer diameter greater than a second portion, wherein the first portion is configured to engage the hub of the elastomeric isolating element when in the loaded condition.

7. The elastomeric bushing and travel limiter assembly of claim 1, further comprising another travel limiter coupled to the inner component and positioned on an opposite end of the inner component as the travel limiter.

8. The elastomeric bushing and travel limiter assembly of claim 7, wherein the another travel limiter is oriented in an opposite direction as the travel limiter.

9. The elastomeric bushing and travel limiter assembly of claim 1, wherein the segments include a first axial length, the first web having a second axial length equal to or less than one third of the first axial length.

10. The elastomeric bushing and travel limiter assembly of claim 1, wherein the segments of the first set of adjacent segments are circumferentially spaced apart by first slots extending from the second ends to the first webs.

11. The elastomeric bushing and travel limiter assembly of claim 10, wherein segments of the second set of adjacent segments are circumferentially spaced apart by second slots extending from the first ends to the second webs.

12. The elastomeric bushing and travel limiter assembly of claim 11, wherein the first slots and the second slots alternate circumferentially around the travel limiter.

13. An elastomeric bushing and travel limiter assembly, comprising:
an inner component;
an outer tube;
an elastomeric isolating element positioned radially between the inner component and the outer tube; and
a travel limiter coupled to the inner component, the travel limiter being ring shaped and including an uninterrupted sidewall circumferentially extending along a serpentine path, the sidewall including an axial first end and an opposite axial second end, wherein first slots extend through the travel limiter from the first end toward the second end and second slots extend from the second end toward the first end, wherein the first slots and the second slots are interdigitated.

14. The elastomeric bushing and travel limiter assembly of claim 13, wherein the first slots terminate at first webs and the second slots terminate at second webs.

15. The elastomeric bushing and travel limiter assembly of claim 14, wherein the first webs are positioned at the axial second end and the second webs are positioned at the axial first end.

16. The elastomeric bushing and travel limiter assembly of claim 14, wherein the travel limiter includes a first axial length, the first webs having a second axial length equal to or less than one third of the first axial length.

17. The elastomeric bushing and travel limiter assembly of claim 14, wherein each one of the first webs are circumferentially spaced apart from one another by one of the second slots.

18. The elastomeric bushing and travel limiter assembly of claim 13, wherein the travel limiter includes an inner cylindrical surface and an outer cylindrical surface aligned along a common axis.

19. The elastomeric bushing and travel limiter assembly of claim 13, wherein the sidewall is spaced apart from a hub of the elastomeric isolating element when in an unloaded condition and the sidewall is configured to engage the hub of the elastomeric isolating element when in a loaded condition to limit the radial movement of the inner component relative to the outer tube.

20. The elastomeric bushing and travel limiter assembly of claim 13, further comprising another travel limiter coupled to the inner component and positioned on an opposite end of the inner component as the travel limiter.
